(19) United States
(12) Patent Application Publication
(10) Pub. No.: US 2010/0077475 A1
(43) Pub. Date: Mar. 25, 2010

(54) PARTIAL INSTALLATION BASED ON AVAILABLE PRIVILEGES

(75) Inventors: Rusty Deschenes, Seattle, WA (US); Jean-Pierre Duplessis, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/234,807

(22) Filed: Sep. 22, 2008

(51) Int. Cl. G06F 12/14; G06F 9/445

(52) U.S. Cl. 726/21; 717/174

(57) ABSTRACT

Component identifications in a package identify components to be installed and/or components to be uninstalled. Each component has one or more install-uninstall-privilege requirements, namely, credentials that must be available to an installer-uninstaller in order to install-uninstall that component. Individual components and component sets are installed and/or uninstalled based on the privilege requirement(s) and the privilege(s) available to a current user of a target system. If required privilege(s) are not available, notice is given and additional privileges are requested. A user may receive partial functionality from a partially completed installation, and additional components may be installed later as more privileges become available.

### BACKGROUND

Computer system functionality can be reduced or destroyed, and data can be lost, altered or stolen, by incorrect or malicious actions. As a security measure, many operating systems enforce limitations on user capabilities by requiring that a user have specified privileges in order to perform a specified action within a computer system. Privileges are generally assigned by an administrator who has administrator rights, which include the right to modify other users' rights. A given human user may have more than one account through which that user exercises functionality of a computer system, and different accounts may have different privileges. Privileges are sometimes organized in levels, e.g., an administrator or elevated level, and a user level. A privilege may also be viewed as belonging to a software process, which is in turn controlled by a user, subject to the user's credentials.

Sometimes administrator privileges are required to install software on a target computer system. Different computer systems may have different configurations, allowing or requiring different actions during installation. Indeed, the same computer system hardware may run in different configurations at different times. Different users of a computer system may also have different rights with regard to accessing and/or modifying the configuration of the computer system. Software may include a variety of components to be installed on a target computer system. If the necessary privileges are not present during an installation attempt, then installation may be prevented by the operating system or by other security mechanisms that enforce privilege requirements.

### SUMMARY

Installation and uninstallation are done on a per-component basis in response to privilege requirements and available privileges, allowing applications to be more resilient in the absence of installation privileges. Some embodiments obtain component identifications identifying respective components to be installed; in some cases, identifications specify components which are already installed and are to be uninstalled. Each component has one or more install-uninstall-privilege requirements, namely, credentials that must be available to an installer-uninstaller in order for the installer-uninstaller to install or uninstall (as the case may be) that particular component. A given installer-uninstaller may be configured to only perform installation, to only perform uninstallation, or to do both depending on the circumstances. Similarly, a given install-uninstall-privilege may provide an installation right, an uninstallation right, or a right to do both.

Some embodiments automatically identify each privilege that is required to install-uninstall a given component, and then automatically ascertain whether the required privilege(s) are available during an attempted install-uninstall. If the required privilege(s) are available, then the component is automatically installed-uninstalled. If the required privilege(s) are not available, some embodiments notify a user and/or an administrator, some embodiments request additional privileges, and some provide a list of components that can be installed-uninstalled at the time based on install-uninstall privilege requirements and the available privileges.

When some but not all privileges needed for a full installation-uninstallation are present, some embodiments automatically install-uninstall less than all of the identified components, thereby allowing a user to exercise a functionality that was previously unavailable. Some embodiments monitor privilege status, and if they discover after a partial install-uninstall that that a necessary privilege has become available, they automatically install-uninstall additional components as permitted by the newly discovered privilege(s).

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a target computer system having a memory configured with installed components, privileges, and other items in an operating environment, and also illustrating configured storage medium embodiments;

FIG. 2 is a block diagram further illustrating an installation-uninstallation package and showing the computer system of FIG. 1 at different times;

FIG. 3 is a flow chart illustrating steps of some method and configured storage medium embodiments; and

FIG. 4 is a flow chart further illustrating method and configured storage medium embodiments.

### DETAILED DESCRIPTION

Overview

Some programs require elevated privileges to install themselves on a computer. A privilege may be required for installation in order to make the program easier to find and launch, in order to allow other programs to discover the program's presence and interact with it, and/or to take advantage of privileged operating system functionality, for example.

A privilege requirement can result in a user being prevented from installing a program even if running the program does not require an elevated privilege. The user may be able to ask someone else to grant the necessary rights to install the program, but that other person may not be immediately available to help.

Some embodiments discussed herein allow some applications to be more resilient when installation privileges are delayed or otherwise missing. Users may still be able to install a portion of such an application, even without all necessary privileges, and may then gain access to at least some of the application's functionality. Moreover, application resilience in the face of incomplete installation privileges does not require lowered or otherwise compromised security.

For example, some embodiments discussed herein provide or use an installer that operates on a component-by-component privilege requirement basis. A partial installation of some but not all components of a software package is performed when the elevated privileges for a full installation are not available, or when the privileges needed for a full installation are only partially available. In some embodiments, a program being installed has been modified such that the partial installation provides a usable program, albeit without the complete functionality that a full installation of the program would provide. In some embodiments, the installer or the installed program allow a user to complete the remaining portion of a partial installation at some later time when the necessary elevated privileges have become available.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Privileges” as used herein are also sometimes referred to in the industry by terms such as “credentials”, “administrative rights”, “access controls”, “access rights”, or simply as “rights”. Unless otherwise indicated, privileges discussed herein are rights related to installing and/or uninstalling components, as opposed to execution rights, modification rights, or other rights enforced by operating systems. However, a given system need not distinguish installation-uninstallation rights from execution rights or other rights in order for the rights in question to be pertinent to an embodiment.

Throughout this document, use of the optional plural “(s)” means that one or more of the indicated feature is present. For example, “privilege(s)” means “one or more privileges” or equivalently “at least one privilege”.

“Code” means processor instructions, data (which includes data structures), or both instructions and data.

Whenever reference is made to data or instructions, it is understood that these items configure a computer-readable memory, as opposed to simply existing on paper, in a person's mind, or as a transitory signal on a wire, for example.

Operating Environments

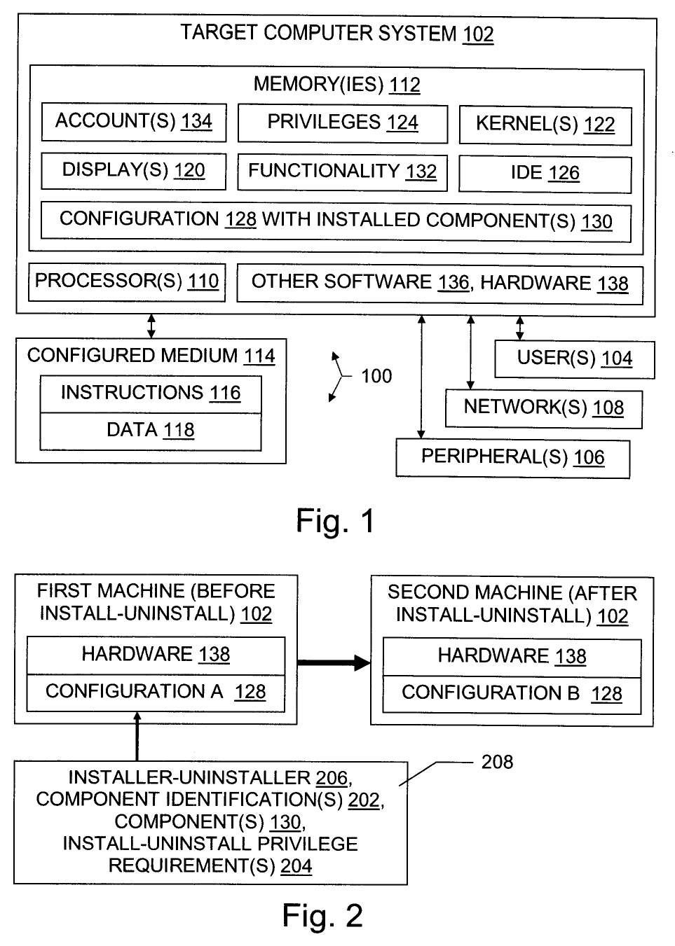

With reference to FIG. 1, an operating environment 100 for an embodiment may include a target computer system 102. The computer system 102 may be a multiprocessor computer system, or not. An operating environment may include one or more computer systems, which may be clustered, client-server networked, and/or peer-to-peer networked. Some operating environments include a stand-alone (non-networked) computer system.

Human users 104 may interact with the computer system 102 by using displays 120, keyboards, and other peripherals 106. A system administrator is understood to be a particular type of user 104; end-users are also considered users 104. Automated agents may also be users 104. Storage devices and/or networking devices may be considered peripheral equipment in some embodiments. Other computer systems (not shown) may interact with the computer system 102 or with another system embodiment using one or more connections to a network 108 via network interface equipment, for example.

The computer system 102 includes at least one logical processor 110. The computer system 102, like other suitable systems, also includes one or more memories 112. The memories 112 may be volatile, non-volatile, fixed in place, removable, magnetic, optical, and/or of other types. In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a memory 112. Other examples of memory 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the memory 112/medium 114 in which they reside; when that memory is a functional part of a given computer system, the instructions 116 and data 118 also configure that computer system. Memories 112 may be of different physical types. Privileges 124 and other items shown in the Figures may reside partially or entirely within one or more memories 112, thereby configuring those memories.

In a given operating environment 100, whether within an Integrated Development Environment (IDE) 126 or otherwise, a current configuration 128 of installed files, registry entries, programs, and other components 130 will be present. The current configuration 128 of installed components 130 provides a given user with particular functionality(ies) 132. That user 104 may receive different functionality(ies) if the configuration 128 changes and/or if the user logs in under a different user account 134. Specific application programs and other software 136 and other hardware 138 than that already enumerated may also be present.

The illustrated configuration includes an Integrated Development Environment 126 which provides a developer with a set of coordinated software development tools. In particular, some of the suitable operating environments for some embodiments include or help create a Microsoft® Visual Studio® development environment (marks of Microsoft Corporation) configured to support source code development according to the teachings herein. Some suitable operating environments include Java® environments (mark of Sun Microsystems, Inc.), and some include environments which utilize languages such as C++ or C# (“C-Sharp”), but teachings herein are applicable with a wide variety of programming languages, programming models, and programs, as well as with endeavors outside the field of software development that involve document editing.

Systems

Referring now to FIGS. 1 and 2, some embodiments provide a computer system 102 having a processor 110 in operable communication with a memory 112 that contains component data 118 in the form of a particular configuration 128 of installed components 130. The configuration 128 is generated in part using component identifications 202 which identify respective components 130.

Components 130 in given configuration 128 may include, for example, executable code component(s), interpreted code component(s), natural language text component(s), source code component(s), markup language component(s), database record component(s), application program component(s), operating system component(s), and/or file component(s). Components 130 may include associated registry entries, access rights, and bibliographic data such as creator names and creation/modification dates.

Each component 130 has at least one install-uninstall-privilege requirement 204 which specifies the privilege(s) 124 needed to install-uninstall that component. Different components 130 may have different install-uninstall-privilege requirements 204.

For a given component or proper subset of components within a package, in some embodiments an installer-uninstaller 206 automatically identifies the privilege(s) required to install-uninstall the component, automatically ascertains whether those privilege(s) are available to the current user on the computer system 102, and automatically installs-uninstalls the component(s) if the required privilege(s) are available. The change in functionality 132 resulting from the installation-uninstallation effectively transforms the target system 102, from a first machine having certain functionality(ies) before the install-uninstall to a second machine having different functionality(ies) after the install-uninstall has changed the configuration 128. The functionality change does not necessarily involve any change to the underlying hardware 138 of the computer system 102.

If the privilege(s) required to install-uninstall the component are not available, the installer-uninstaller 206 may request the privilege(s) from the user running the installation-uninstallation attempt, from an administrative user, and/or directly from the kernel 122. In some cases, the necessary privilege(s) will be obtained and the installation-uninstallation will proceed to completion with little or no inconvenience to the user(s).

In other cases, the privilege(s) necessary to complete installation-uninstallation are not obtained. Faced with a lack of privilege(s), however, some embodiments include a user-selectable partial installation-uninstallation option, and some automatically perform a partial installation-uninstallation.

Various factors may be significant in a given embodiment when components are selected for a partial installation-uninstallation. Some potentially significant factors include the functionality 132 that would be provided by installing-uninstalling particular components or component sets, and the installation-uninstallation privilege requirements 204 in comparison with the available privilege(s) 124. An installer-uninstaller 206 may include rules or otherwise be designed for handling various situations involving factors such as user convenience, available privilege(s), component installation-uninstallation privilege requirements, and the functionality impact of a component installation-uninstallation.

For example, an installer-uninstaller 206 may be designed to simply install-uninstall all the components 130 of a given package 208 that can be installed-uninstalled under the current privilege(s), even if some of those component installation(s)-uninstallation(s) individually have no effect on functionality because they operate only in conjunction with another component installation-uninstallation that is currently barred by lack of privilege(s). By contrast, an installer-uninstaller 206 may be designed to install-uninstall components in functionality sets that are proper subsets of a package; each such set alters functionality 132. An installer-uninstaller may be designed to not install-uninstall a given component 130 unless the necessary privilege(s) are available to install-uninstall all components of that component's functionality set. Membership in functionality sets may be specified by the vendor or developer who provided the components in the package.

Although FIG. 2 shows an installer-uninstaller 206 as part of a package 208 that also contains components 130 and other items, in some embodiments the installer-uninstaller 206 is separate from the package of components. For instance, the installer-uninstaller 206 may be part of an operating system or other kernel 122.

Other package 208 variations are also possible. For example, for a pure uninstallation where no installation occurs, a package 208 may lack components 130, instead containing only component identification(s) 202 and corresponding uninstallation privilege requirement(s) 204. A package 208 for a combined installation and uninstallation may contain only components 130 to be installed, with corresponding installation privilege requirement(s) 204 and identifications 202, and identifications 202 of components to be uninstalled with corresponding uninstallation privilege requirement(s) 204.

As noted, a computer system 102 configured by a partial installation-uninstallation may provide different functionality after the partial installation-uninstallation changes the configuration 128. FIG. 2 shows two configurations, denoted by A and B, which reflect functionality changes after an installation-uninstallation (full or partial). A user may do a partial installation-uninstallation, be prevented from finishing by lack of privilege(s), and nonetheless benefit from application resilience by exercising new functionality on the computer system 102, namely, functionality that was not present before the partial installation-uninstallation.

For example, if functionality feature A and functionality feature B are implemented independently of each other, aside from being included in the same installation package, and if code for one of A and B is installed but code for the other is not installed, then the user may exercise the installed feature. Similarly, if feature B depends on the availability of feature A but the reverse is not true, and feature A is installed, then A could be used even if B is not installed. More generally, an installed feature may be used to the extent it is independent of other features that were not installed.

When an application is divided into functionality sets to provide resilience in the absence of some of those functionality sets due to inadequate installation privilege(s), several points should be kept in mind. Each potentially separate functionality set could avoid casually incorporating assumptions as to what has been installed, by expressly checking for installed components instead, for example. Likewise, each component could be designed to degrade gracefully in the absence of another component, e.g., by providing a friendly non-fatal error message to the user, by silently ignoring no-fatal errors, and/or by notifying the user through a glyph that additional functionality can be installed if adequate privilege(s) are obtained. The installer could also be designed to be aware of functionality sets within an application and of the dependencies between them. For example, an installer may be informed that functionality set one runs best if sets two and three are also installed, but set one also runs with restricted features if only set two can be installed along with set one.

In some embodiments, the installer-uninstaller 206 remains on the system 102 after the installation-uninstallation, either as a standalone program, as part of a kernel, or as a part of an installed application program. Suppose changes in available privilege(s) occur after partial installation-uninstallation of a given package 208, for reasons that may be unrelated to the package 208. The privilege changes may make it possible to install-uninstall additional package 208 components. The installer-uninstaller 206 may discover, through polling, event notification, or another mechanism, that additional necessary privilege(s) are now available. Upon discovering such additional privilege(s), the installer-uninstaller 206 may notify the user and request permission to exercise the privilege(s), or the installer-uninstaller 206 may automatically exercise the additional privilege(s) to install-uninstall additional component(s). The additional component(s) may complete the partial installation-uninstallation, creating a full installation-uninstallation of the package 208.

In some embodiments, the installer-uninstaller 206 has the following capabilities. The installer-uninstaller can separate actions according to the privilege(s) required, namely, it distinguishes installation-uninstallation actions that require certain privilege(s) from actions that require less or otherwise different privilege(s). The installer-uninstaller can determine what privilege(s) each component installation-uninstallation requires. At install time, the installer-uninstaller can determine the privilege(s) available, e.g., from the current privilege level, or by querying the operating system. If required privilege(s) are not available, the installer-uninstaller can prompt the user to pick an option such as the following. The user may provide a different credential that includes additional privilege(s). The user may select a subset of the current package's install-uninstall steps to execute, based on privilege requirements and privilege availability. The user may perform a combination of the two previous options, thereby providing additional privilege(s) but not providing all of the privilege(s) required for a full installation-uninstallation.

A program which contains multiple components may be modified for placement in a package 208 so that a proper subset of program components which is installed by the installer can work properly. Program features which are not installed, due to lack of privilege(s), are disabled or fail gracefully when a user invokes them after the partial installation. Accordingly, a useful part of a program could be installed and used by a user who has limited installation privilege(s). At a later time which is convenient to the user and at which the user can gain additional privilege(s), the user can let the installer make further progress toward a complete installation of the program.

In some embodiments, peripherals 106 such as human user I/O devices (screen, keyboard, mouse, microphone, speaker, motion sensor, etc.) will be present in operable communication with one or more processors 110 and memory 112. However, an embodiment may also be deeply embedded in a system, such that no human user 104 interacts directly with the embodiment. Software processes may be users 104.

In some embodiments, networking interface equipment provides access to networks 108, using components such as a packet-switched network interface card, a wireless transceiver, or a telephone network interface, for example, will be present in the computer system. However, an embodiment may also communicate through direct memory access, removable nonvolatile media, or other information storage-retrieval and/or transmission approaches, or an embodiment in a computer system may operate without communicating with other computer systems.

Some embodiments provide a computer system 102 having a memory 112 which contains component data 118 generated by the following method. The system obtains 402 a plurality of component identifications 202 identifying respective components 130. Each component 130 has at least one respective install-uninstall-privilege requirement 204; in some cases, at least two of the components have different respective install-uninstall-privilege requirements 204. For a given component, the system identifies 404 at least one privilege 124 that is required to install-uninstall 416 the component. The system ascertains 406 whether the at least one privilege required to install-uninstall the component is available to the current user 104 on the system. The system installs-uninstalls the component in the memory 112 if the at least one privilege required to install-uninstall the component is available. The processor(s) 110 work in operable communication with the memory 112 to facilitate the method, e.g., by running an installer-uninstaller. In some embodiments, the method configuring the memory 112 further includes requesting 412 that the at least one privilege required to install-uninstall a component be made available to a user on the computer system.

In some embodiments, the method does 308 a partial install-uninstall, e.g., by automatically installing-uninstalling less than all of the identified components. A functionality 132 on the system 102 which was unavailable prior to those installs-uninstalls and which is available without further installs-uninstalls is then exercised 428 on behalf of a user 104. A package 208 and an installer-uninstaller 206 may be designed such that a full install-uninstall is not required to provide at least part of the package's intended change in system functionality.

In some embodiments, the method automatically installs-uninstalls less than all of the identified components, notifies 418 a user during or after an installation attempt complete install-uninstall will not be/was not achieved due to a lack of necessary privilege(s). In some embodiments, an application which was only partially installed displays to its users an icon, glyph, dialog, or other notification that the application's functionality is currently limited due to a lack of installation privilege(s); specific missing features and/or lacking privileges may be identified to the user. In some cases, the method later automatically discovers 430 that a necessary privilege has become available. The method may then automatically exercise 428 that privilege to install-uninstall another component 130, or it may automatically request 412 permission 414 from a user to exercise that privilege.

In some cases, the method does 304 install-uninstall all of the components identified in a given package 208. A full installation-uninstallation may be achieved in one session, or it may be achieved over multiple sessions with intervening use(s) of the system for purposes other than performing an install-uninstall.

Examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

Methods

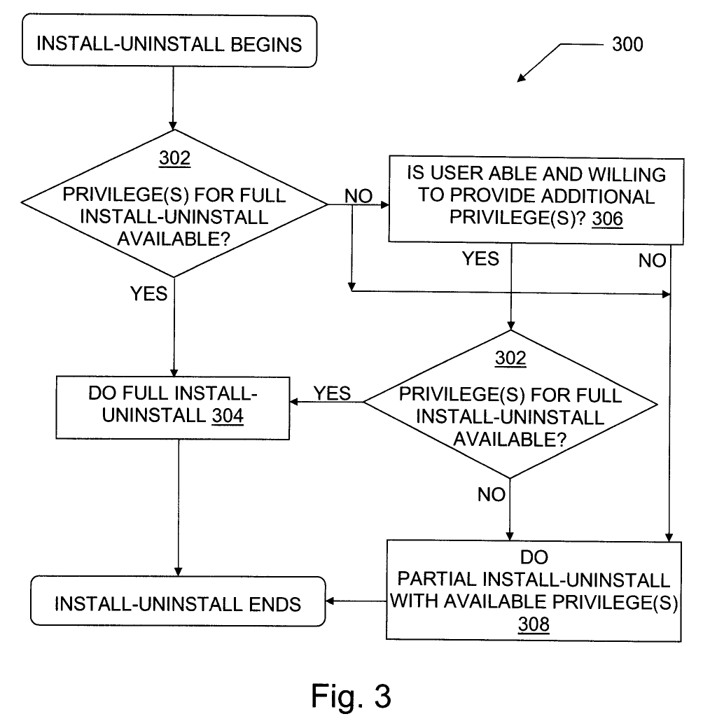

FIG. 3 illustrates some method embodiments in a flowchart 300. Methods shown in the Figures may be performed in some embodiments automatically, e.g., by an installer-uninstaller 206 designed to operate with little or no user input. Methods may also be performed in part automatically and in part manually unless otherwise indicated.

An install-uninstall may begin in response to a command or other action from a local user, or in response to a remote user. A decision 302 is made in response to the install-uninstall privilege requirement(s) 204 for the package being installed-uninstalled and the available privilege(s) 124. If all privilege(s) 124 required for a full install-uninstall are available, then the full install-uninstall is done in a step 304, and the current install-uninstall method instance ends. For convenient illustration, a full install-uninstall is represented in FIG. 3 as a single step, but multiple reads, writes, lookups, copies, notifications, and other actions may occur during the course of an install-uninstall, whether full or partial.

If one or more privilege(s) 124 required for a full install-uninstall are not available, then the user may optionally be asked to provide additional privilege(s) during a step 306. If the user is both willing and able to provide additional privilege(s) then the decision 302 is again made as to whether all privilege(s) 124 required for a full install-uninstall are now available, and if they are, the full install-uninstall is done. If the privilege(s) 124 required for a full install-uninstall are not available, then a partial install-uninstall is done in a step 308. In the illustrated method, the partial install-uninstall is done regardless of whether additional privilege(s) were made available by the user in step 306. After the partial install-uninstall, the current install-uninstall method instance ends.

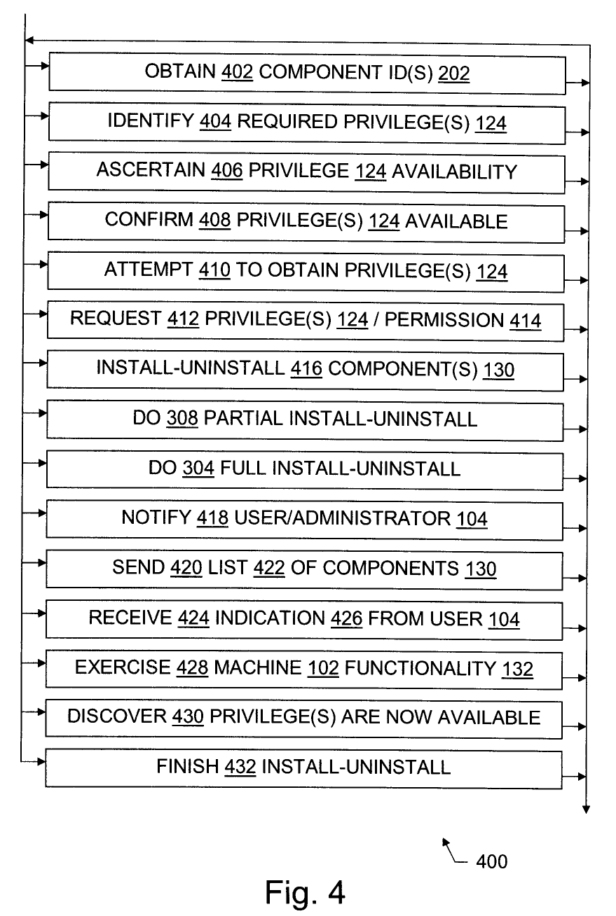

FIG. 4 further illustrates method embodiments in a flowchart 400. In a given embodiment zero or more illustrated steps of a method may be repeated, perhaps with different parameters or data to operate on. Steps in an embodiment may also be done in a different order than the top-to-bottom order that is laid out in FIG. 4. Steps may be performed serially, in a partially overlapping manner, or fully in parallel. The order in which flowchart 400 is traversed to indicate the steps performed during a method may vary from one performance of the method to another performance of the method. The flowchart traversal order may also vary from one method embodiment to another method embodiment. Steps may also be omitted, combined, renamed, regrouped, or otherwise depart from the illustrated flow, provided that the method performed is operable and conforms to at least one claim.

During an obtaining step 402, an embodiment obtains component identifications 202 identifying component(s) to be installed-uninstalled. The component identifications 202 may be read from a package 208 and/or entered interactively by a user 104, for example.

During an identifying step 404, an embodiment identifies privilege(s) that are required to install-uninstall a component 130. Required privilege(s) may be identified by reading install-uninstall privilege requirement(s) 204 from a package 208 and/or by communicating with a kernel 122, for example. In particular, in some embodiments when a kernel denies an install-uninstall process's request because the process lacks required privilege(s), the kernel also identifies the required privilege(s) to the denied process.

During an ascertaining step 406, an embodiment ascertains whether privilege(s) required for an install-uninstall are available. In one variation, ascertaining step 406 queries a kernel 122 to obtain a list of credentials belonging to the current user under the current account 134 for which the install-uninstall is being attempted, and compares that list with the install-uninstall privilege requirement(s) 204 for the install-uninstall. In another variation, ascertaining step 406 obtains a list of credentials belonging to the current user 104 under multiple accounts 134 held by that user 104, including account(s) under which the user is not currently logged in. In another variation, ascertaining step 406 starts with a list of install-uninstall privilege requirement(s) 204 for the install-uninstall and then queries a kernel 122 to ascertain which of those requirement(s) is satisfied. In another variation, ascertaining step 406 attempts an action that requires privilege(s) that are also required for the install-uninstall and ascertains the availability of the privilege(s) from the success/failure of the action. The action may be an attempt to install-uninstall a component 130 in the install-uninstall package 208, or the action may be an innocuous test action used with multiple packages 208.

During a confirming step 408, an embodiment confirms that privilege(s) required for an install-uninstall are available. Confirming step 408 results in confirmation that privilege(s) required for an install-uninstall are available, whereas ascertaining step 406 ascertains whether such privilege(s) are available. Confirming step 408 otherwise proceeds similarly to ascertaining step 406.

During an attempting step 410, an embodiment attempts to obtain install-uninstall privilege(s) that are not available. For example, the embodiment may request privilege(s) from a kernel 122, from the user 104 who initiated the current install-uninstall, and/or from a system administrative user 104. Attempting step 410 may use a kernel's security application program interface, or a graphical user interface, for example. Attempting step 410 may include communication over a network 108 with a remote user 104 and/or a remote kernel 122.

During a requesting step 412, an embodiment requests install-uninstall privilege(s) and/or requests permission 414 to exercise install-uninstall privilege(s). Requesting step 412 may occur during attempting step 410 when an embodiment requests privilege(s) in an attempt to obtain privilege(s) required for an install-uninstall. As a matter of courtesy or administrative protocol, or as a precaution, requesting step 412 may request permission 414 from a user 104 to exercise install-uninstall privilege(s) that are available and that could be exercised without such permission.

During an installing-uninstalling step 416, an embodiment installs and/or uninstalls one or more components 130, thereby changing the configuration 128 of at least one computer system 102.

During a partial install-uninstall doing step 308, an embodiment does a partial install-uninstall, namely, installs-uninstalls 416 less than all components 130 of a given package 208. “Less than all” includes “none” as a possibility for any package 208, as well as including “one or more but not all” as a possibility for packages 208 that contain identification(s) 202 of multiple components.

During a full install-uninstall doing step 304, an embodiment does a full install-uninstall, namely, installs-uninstalls 416 all component(s) 130 of a given package 208.

During a notifying step 418, an embodiment provides a notification for a current user 104 and/or an administrative user 104. For example, the notification may state that a complete install-uninstall was not achieved due to a lack of necessary privilege(s). Similarly, an embodiment may automatically notify an administrator, without necessarily notifying a current non-administrative user, if a privilege required to install-uninstall a component is not available to that current non-administrative user.

During a sending step 420, an embodiment sends a user 104 a list 422 of component(s) 130 which can be installed-uninstalled 416, at least so far as privilege(s) are concerned; disk space, connectivity, and other considerations may hamper an install-uninstall even if privilege requirement(s) 204 are satisfied. The list 422 may be generated by comparing package 208 component identifications 202 and their privilege requirement(s) 204 with the privileges 124 available. The list 422 may be generated before, during, and/or after one or more of steps 304, 308, 406-418, for example.

During a receiving step 424, an embodiment receives from a user 104 an indication 426 of component(s) 130 the user wishes to have installed-uninstalled 416. Instance(s) of receiving step 424 may occur independently of, prior to, interleaved with, and/or after, instance(s) of sending step 420.

During an exercising step 428, an embodiment exercises functionality 132 of a machine on behalf of a user 104.

During a discovering step 430, an embodiment discovers that a previously unavailable install-uninstall privilege 124 has become available. Such a discovery may result from repeated queries to a kernel, from periodic attempts to take an action requiring a privilege, or from notification provided by a kernel or a user, for example.

During a finishing step 432, an embodiment releases file handles, memory, semaphores, and other resources held during an install-uninstall. Report(s) to a user(s) may also be provided.

Some embodiments provide a process for transforming a first machine into a second machine by modifying functionality 132 of the first machine to form the second machine. Each machine is a computer system 102 having at least one respective processor 110 and respective memory(ies) 112 configured by respective component data 118. The process includes obtaining 402 a plurality of component identifications identifying respective components, each component having at least one respective install-uninstall-privilege requirement. For a given component, the process automatically identifies 404 at least one privilege that is required to install-uninstall the component, automatically confirms 408 that the required privilege(s) is available to the current user on the first machine, and installs-uninstalls 416 the component on the first machine, thereby transforming the first machine into the second machine by modifying functionality of the first machine to form the second machine.

In some embodiments, the process automatically identifies 404 at least two different privileges 124 respectively required to install-uninstall two different components 130. In some embodiments, the process automatically installs-uninstalls 416 less than all of the identified components, and a functionality 132 of the second machine which was unavailable prior to the installs-uninstalls and is available without further installs-uninstalls is exercised 428 on behalf of a user. In some embodiments, the process automatically installs-uninstalls 416 all of the identified components. In some embodiments, privileges 124 required to install-uninstall identified components are organized in privilege levels, such as an end-user level and an administrative user or superuser level. Other process variations are also possible.

Configured Media

Some embodiments include a configured computer-readable storage medium 114, which is an example of a memory 112. Memory 112 may include disks (magnetic, optical, or otherwise), RAM, EEPROMS or other ROMs, and/or other configurable memory. The storage medium which is configured may be in particular a removable storage medium 114 such as a CD, DVD, or flash memory. A general-purpose memory 112, which may be removable or not, and may be volatile or not, can be configured into an embodiment using items such as install-uninstall privilege requirement(s) 204, component identification(s) 202, installer-uninstaller(s) 206, and package(s) 208, in the form of data 118 and instructions 116, read from a removable medium 114 and/or another source such as a network connection, to form a configured medium. The configured memory 112 is capable of causing a computer system to perform method steps for installing-uninstalling component(s) based on their respective privilege requirement(s) 204 and available privilege(s) 124 as disclosed herein. FIGS. 3 and 4 thus help illustrate configured storage media embodiments and method embodiments, as well as system and method embodiments. In particular, any of the method steps illustrated in FIG. 3 and/or FIG. 4, or otherwise taught herein, may be used to help configure a storage medium to form a configured medium embodiment.

Some embodiments provide a storage medium 114 configured with computer code 116,118 for a method of partially installing a set of components based on privileges that are available to a user on a computer system. The method includes obtaining 402 a plurality of component identifications 202 identifying respective components 130, each component having at least one respective install-uninstall-privilege requirement 204, at least two of the components having different respective install-uninstall-privilege requirements. For a given component, the method automatically identifies 404 at least one privilege that is required to install-uninstall 416 the component, and automatically ascertains 406 whether the privilege is available to the current user 104 on the computer system 102 which is the target of the install-uninstall. The method automatically installs-uninstalls 416 the component in the computer system memory 112 if the privilege required is available. The method repeats steps until multiple components have been installed-uninstalled on the computer system.

In some embodiments, the ascertaining step ascertains 406 that the at least one privilege required to install-uninstall the component is not available to the current user on the computer system. The method further includes sending 420 a list 422 of components that can be installed-uninstalled at this time based on install-uninstall privilege requirements and privileges currently available to the user on the computer system, and receiving 424 an indication 426 of which components should be installed-uninstalled at this time.

In some embodiments, the method automatically notifies 418 an administrator if a privilege required to install-uninstall a component is not available to the current user on the computer system.

In some embodiments, the ascertaining step ascertains 406 that a privilege required to install-uninstall a component is not available to the current user on the computer system, and the method attempts 410 to have the privilege made available, e.g., by asking the user for additional privileges. In particular, it may occur that a person with a necessary privilege under one account 134 is logged in and attempting to do the install-uninstall under a different account which lacks the necessary privilege. The method may attempt 410 to obtain rights by asking this person to log in under the more privileged account to complete the install-uninstall.

In some embodiments, the method automatically installs-uninstalls less than all of the identified components, but the user still receives some benefit even though the install-uninstall was only partial. That is, a functionality 132 of the computer system which was unavailable prior to the installs-uninstalls and is available without further installs-uninstalls is exercised 428 on behalf of a user. In some embodiments, the method later automatically discovers 430 that a necessary privilege has become available and then installs-uninstalls another of the identified components.

### Conclusion

Although particular embodiments are expressly illustrated and described herein as methods, as configured media, or as systems, it will be appreciated that discussion of one type of embodiment also generally extends to other embodiment types. For instance, the descriptions of methods in connection with FIGS. 3 and 4 also help describe configured media, and help describe the operation of systems and manufactures like those discussed in connection with FIGS. 1 and 2. It does not follow that limitations from one embodiment are necessarily read into another. In particular, methods are not necessarily limited to the data structures and arrangements presented while discussing systems or manufactures such as configured memories.

Not every item shown in the Figures need be present in every embodiment. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or methodological acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A process for transforming a first machine into a second machine by modifying functionality of the first machine to form the second machine, each machine having a respective processor and a respective memory configured by respective component data, the process comprising the steps of:
(a) obtaining a plurality of component identifications identifying respective components, each component having at least one respective install-uninstall-privilege requirement;
(b) for a given component, automatically identifying at least one privilege that is required to install-uninstall the component;
(c) automatically confirming that the at least one privilege required to install-uninstall the component is available to the current user on the first machine; and
(d) installing-uninstalling the component on the first machine, thereby transforming the first machine into the second machine by modifying functionality of the first machine to form the second machine.

2. The process of claim 1, wherein the process automatically identifies at least two different privileges respectively required to install-uninstall two different components.

3. The process of claim 1, wherein the process automatically installs-uninstalls less than all of the identified components, and a functionality of the second machine which was unavailable prior to the installs-uninstalls and is available without further installs-uninstalls is exercised on behalf of a user.

4. The process of claim 1, wherein the process automatically installs-uninstalls all of the identified components.

5. The process of claim 1, wherein privileges required to install-uninstall identified components are organized in privilege levels.

6. A computer system comprising:
a memory which contains component data generated by the following method:
(a) obtaining a plurality of component identifications identifying respective components, each component having at least one respective install-uninstall-privilege requirement, at least two of the components having different respective install-uninstall-privilege requirements;
(b) for a given component, automatically identifying at least one privilege that is required to install-uninstall the component;
(c) ascertaining whether the at least one privilege required to install-uninstall the component is available to the current user on the computer system; and
(d) installing-uninstalling the component in the computer system memory if the at least one privilege required to install-uninstall the component is available to the current user on the computer system; and
a processor in operable communication with the memory to facilitate the method.

7. The computer system of claim 6, wherein the method obtains a component identification identifying at least one of the following: an executable code component, an interpreted code component, a natural language text component, a source code component, a markup language component, a database record component, an application program component, an operating system component, a file component.

8. The computer system of claim 6, wherein the method further includes requesting that the at least one privilege required to install-uninstall a component be made available to a user on the computer system.

9. The computer system of claim 6, wherein the method automatically installs-uninstalls less than all of the identified components, and a functionality on the computer system which was unavailable prior to the installs-uninstalls and is available without further installs-uninstalls is exercised on behalf of a user.

10. The computer system of claim 6, wherein the method installs-uninstalls all of the identified components.

11. The computer system of claim 6, wherein the method automatically installs-uninstalls less than all of the identified components; then notifies a user that complete install-uninstall was not achieved due to a lack of necessary privilege(s); and later automatically discovers that a necessary privilege has become available.

12. The computer system of claim 11, wherein after automatically discovering that a necessary privilege has become available, the method automatically exercises that privilege to install-uninstall a component.

13. The computer system of claim 11, wherein after automatically discovering that a necessary privilege has become available, the method automatically requests permission from a user to exercise that privilege to install-uninstall a component.

14. A storage medium configured with computer code for a method of partially installing a set of components based on privileges that are available to a user on a computer system, the method comprising the steps of:
(a) obtaining a plurality of component identifications identifying respective components, each component having at least one respective install-uninstall-privilege requirement, at least two of the components having different respective install-uninstall-privilege requirements;
(b) for a given component, automatically identifying at least one privilege that is required to install-uninstall the component;
(c) automatically ascertaining whether the at least one privilege required to install-uninstall the component is available to the current user on the computer system;
(d) automatically installing-uninstalling the component in the computer system memory if the at least one privilege required to install-uninstall the component is available to the current user on the computer system; and
(e) repeating at least steps (b) through (d) until multiple components identified during step (a) have been installed-uninstalled on the computer system.

15. The configured medium of claim 14, wherein the ascertaining step ascertains that the at least one privilege required to install-uninstall the component is not available to the current user on the computer system, and the method further comprises:
sending a list of components that can be installed-uninstalled at this time based on install-uninstall privilege requirements and privileges currently available to the user on the computer system; and
receiving an indication of which components should be installed-uninstalled at this time.

16. The configured medium of claim 14, wherein the method further comprises automatically notifying an administrator if a privilege required to install-uninstall a component is not available to the current user on the computer system.

17. The configured medium of claim 14, wherein the ascertaining step ascertains that a privilege required to install-uninstall a component is not available to the current user on the computer system, and the method further comprises attempting to have the privilege made available.

18. The configured medium of claim 14, wherein the method automatically installs-uninstalls less than all of the identified components, and a functionality of the computer system which was unavailable prior to the installs-uninstalls and is available without further installs-uninstalls is exercised on behalf of a user.

19. The configured medium of claim 14, wherein the method obtains a component identification identifying at least one of the following: an executable code component, an interpreted code component, a source code component, a markup language component, a database record component.

20. The configured medium of claim 14, wherein the method automatically installs-uninstalls less than all of the identified components; then notifies a user that complete install-uninstall was not achieved due to a lack of necessary privilege(s); and later automatically discovers that a necessary privilege has become available and then installs-uninstalls another of the identified components.
